(19) United States
(12) Patent Application Publication
(10) Pub. No.: US 2017/0315882 A1
(43) Pub. Date: Nov. 2, 2017

(54) PROTECTED WRITE-BACK CACHE TRANSACTION REPLICATION

(71) Applicant: NetApp, Inc., Sunnyvale, CA (US)

(72) Inventors: Ghassan Abdallah Yammine, Leander, TX (US); Derek William Beard, Austin, TX (US)

(21) Appl. No.: 15/143,473

(22) Filed: Apr. 29, 2016

(51) Int. Cl. G06F 11/14; G06F 17/30; G06F 9/46

(52) U.S. Cl. CPC G06F 11/1471; G06F 17/302; G06F 17/30578; G06F 17/30377; G06F 9/467; G06F 17/3007; G06F 11/1474; G06F 2201/80

(57) ABSTRACT

Systems and methods for replicating object-based operations generated based on file system commands are disclosed. In an aspect, an object storage backed file system (OSFS) translates each of multiple file system commands into a respective transaction group of one or more object-based operations. A transaction identifier is assigned to the object-based operations in each of the transaction groups. An OSFS cache records the transaction groups to an intent log that buffers the transaction groups prior to commitment of the object-based operations to a backend object store. The OSFS cache determines for each of the transaction groups, whether the transaction group modifies a file system namespace. During committing of the object-based operations to the backend object store, for each transaction group that is determined to modify the file system namespace, and prior to committing object-based operations of the transaction group, the OSFS cache generates a recovery-begin object that describes the transaction group and stores the recovery-begin object to the backend object store.

### TECHNICAL FIELD

The disclosure generally relates to the field of data storage systems, and more particularly to providing protected replication of file system transactions to object-based storage system.

### BACKGROUND

Network-based storage is commonly utilized for data backup, geographically distributed data accessibility, and other purposes. In a network storage environment, a storage server makes data available to clients by presenting or exporting to the clients one or more logical containers of data. There are various forms of network storage, including network attached storage (NAS) and storage area network (SAN). For NAS, a storage server services file-level requests from clients, whereas SAN storage servers service block-level requests. Some storage server systems support both file-level and block-level requests.

There are multiple mechanisms and protocols utilized to access data stored in a network storage system. For example, a Network File System (NFS) protocol or Common Internet File System (CIFS) protocol may be utilized to access a file over a network in a manner similar to how local storage is accessed. The client may also use an object protocol, such as the Hypertext Transfer Protocol (HTTP) protocol or the Cloud Data Management Interface (CDMI) protocol, to access stored data over a LAN or over a wide area network such as the Internet.

Object-based storage (OBS) is a scalable system for storing and managing data objects without using hierarchical naming schemas. OBS systems integrate, or “ingest,” variable size data items as objects having unique ID keys into a flat name space structure. Object metadata is typically stored with the objects themselves rather than in a separate file system metadata structure. Objects are accessed and retrieved using key-based searching implemented via a web services interface such as one based on the Representational State Transfer (REST) architecture or simple object access protocol (SOAP). This allows applications to directly access objects across a network using “get” and “put” commands without having to process more complex file system and/or block access commands.

Relatively direct application access to stored data is often beneficial since the application has a more detailed operation-specific perspective of the state of the data than an intermediary storage utility package would have. Direct access also provides increased application control of I/O responsiveness. However, direct OBS access is not possible for file system applications due to the substantial differences in access APIs, transaction protocols, and naming schemas. A NAS gateway may be utilized to provide OBS access to applications that use non-OBS compatible APIs and naming schemas. Such gateways may provide a translation layer that enables applications to access OBS without modification using, for example, NFS or CIFS. However, such gateways may interfere with native OBS access (e.g., S3 access) and, furthermore, may not provide the adjustable data access granularity and transaction responsiveness that are typical of file system protocols.

### BRIEF DESCRIPTION OF THE DRAWINGS

Aspects of the disclosure may be better understood by referencing the accompanying drawings.

FIG. 1 depicts a network storage system that provides object-based storage (OBS) access to file system clients;

FIG. 2 is a block diagram illustrating an OBS bridge cluster deployment;

FIG. 3 is a block diagram depicting an OSFS cache;

FIG. 4 is a block diagram illustrating OSFS cache components for replicating updates to an OBS;

FIG. 5 is a flow diagram illustrating operations and functions for processing file system commands;

FIG. 6 is a flow diagram depicting operations and functions for replicating updates to an OBS backend;

FIG. 7 is a flow diagram illustrating operations and functions for coalescing write operations;

FIG. 8 is a flow diagram depicting operations and functions for ensuring atomicity of transaction group commitment to backend object store; and

FIG. 9 depicts an example computer system that includes an object storage backed file system cache.

### DESCRIPTION

### Terminology

A file system includes the data structures and methods/functions used to organize file system objects, access file system objects, and maintain a hierarchical namespace of the file system. File system objects include directories and files. Since this disclosure relates to object-based storage (OBS) and objects in OBS, a file system object is referred to herein as a “file system entity” instead of a “file system object” to reduce overloading of the term “object.” An “object” refers to a data structure that conforms to one or more OBS protocols. Thus, an “inode object” in this disclosure is not the data structure that represents a file in a Unix® type of operating system.

This description also uses “command,” “operation,” and “request” and in a manner to reduce overloading of these terms. Although these terms can be used as variants of a requested action, this description aligns the terms with the protocol and source domain of the requested action. The description uses “file system command” or “command” to refer to a requested action defined by a file system protocol and received from or sent to a file system client. The description uses “object-based operation” or “operation” to refer to a requested action defined by an object-based storage protocol and generated by an object storage backed file system. The description uses “object storage request” to refer to an action defined by a specific object-based storage protocol (e.g., S3) and received from or sent to an object-based storage system.

Overview

The disclosure describes a system and program flow that enable file system protocol access to OBS storage that is compatible with native OBS protocol access and that preserve self-consistent views of the storage configuration state. An OBS bridge includes an object storage backed file system (OSFS) that receives and processes file system commands. The OSFS includes command handlers or other logic to map the file system commands into object-based operations that employ a generic OBS protocol. The mapping may require generating one or more object-based operations corresponding to a single file system command, with the one or more object-based operations forming a file system transaction. To enable access to OBS objects by file system clients, the OSFS augments OBS object representations such that each object is represented by an inode object and an associated namespace object. The inode object contains a key by which it is referenced, object content (e.g., user data), and metadata. The namespace object contains namespace information including a file system name of the inode object and an association between the file system name and the associated inode objects key value. Organized in this manner within a distinct object, the namespace information enables file system access to the inode object while also enabling useful decoupling of the namespace object for namespace transactions such as may be requested by a file system client. The decoupling also enables native object-based storage applications to directly access inode objects.

The disclosure also describes methods and systems that bridge the I/O performance gap between file systems and OBS systems. For example, file systems are structured to enable relatively fast and efficient partial updates of files resulting in reduced latency. Traditional object stores process each object as a whole using object transfer protocols such as RESTful protocols. The disclosure describes an intermediate storage and processing feature referred to as an OSFS cache that provides data and storage state protection and leverages the aforementioned filename/object duality to improve I/O performance for file system clients.

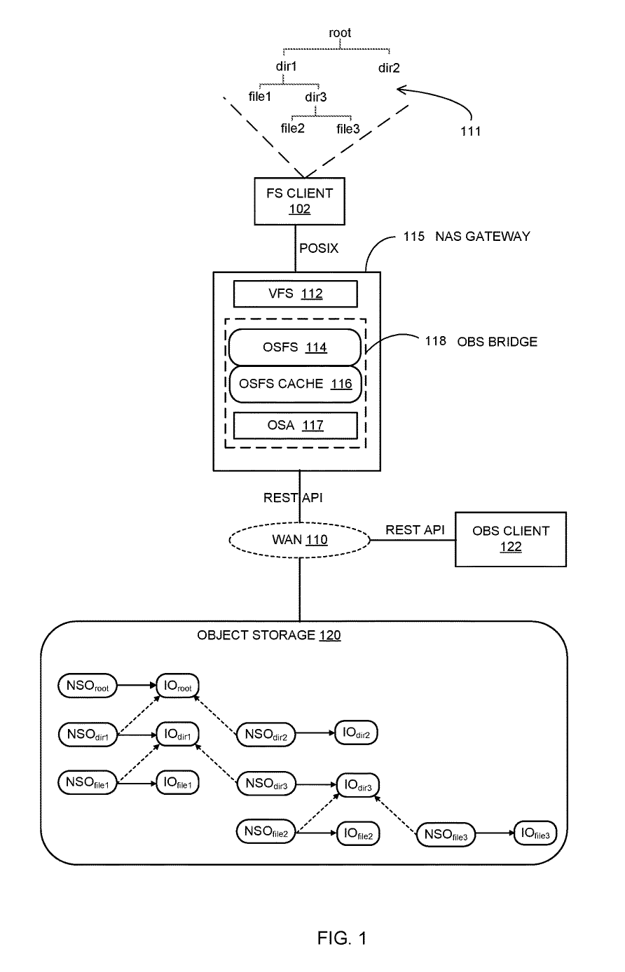

FIG. 1 depicts a storage server environment that provides file system protocol access to an object-based storage (OBS) system. The storage server environment includes an OBS client 122 and a file system client 102 that access an object storage 120 using various devices, media, and communication protocols. Object storage 120 may include one or more storage servers (not depicted) that access data from storage hardware devices such as hard disk drives and/or solid state drive (SSD) devices (not depicted). The storage servers service client storage requests across a wide area network (WAN) 110 through web services interfaces such as Representational State Transfer (REST) based interface or (RESTful interface) and simple object access protocol (SOAP).

OBS client 122 is connected relatively directly to object storage 120 over WAN 110. OBS client 122 may be, for example, a Cloud services client application that uses web services calls to access object-based storage items (i.e., objects). OBS client 122 may, for example, access objects within object storage 120 using direct calls based on a RESTful protocol. It should be noted that reference as a “client” is relative to the focus of the description, as either OBS client 122 and/or file system client 102 may be a “server” if configured in a file sharing arrangement with other servers. Unlike OBS client 122, file system client 102 comprises a file system application, such as a database application that is supported by an underlying Unix® style file system. File system client 102 utilizes file system based networking protocols common in NAS architectures to access file system entities such as files and directories configured in a hierarchical manner. For example, file system client 102 may utilize the network file system (NFS) or Common Internet File System (CIFS) protocol.

A NAS gateway 115 provides bridge and NAS server services by which file system client 102 can access and utilize object storage 120. NAS gateway 115 includes hardware and software processing features such as a virtual file system (VFS) switch 112 and an OBS bridge 118. VFS switch 112 establishes the protocols and persistent namespace coherency by which to receive file system commands from and send responses to file system client 102. OBS bridge 118 includes an object storage backed file system (OSFS) 114 and an associated OSFS cache 116. Together, OSFS 114 and OSFS cache 116 create and manage objects in object storage 120 to provide a hierarchical file system namespace 111 (“file system namespace”) to file system client 102. The example file system namespace 111 includes several file and directory entities distributed across three directory levels. The top-level root directory, root, contains child directories dir1 and dir2. Directory dir1 contains child directory dir3 and a file, file1. Directory dir3 contains files file2 and file3.

OSFS 114 processes file system commands in a manner that provides an intermediate OBS protocol interface for file system commands, and that simultaneously generates a file system namespace, such as file system namespace 111, to be utilized in OBS bridge transactions and persistently stored in backend object storage 120. To create the file system namespace, OSFS 114 generates a namespace object and a corresponding inode object for each file system entity (e.g., file or directory). To enable transaction protocol bridging, OSFS 114 generates related groups of object-based operations corresponding to each file system command and applies the dual object per file system entity structure.

File system commands, such as from file system client 102, are received by VFS switch 112 and forwarded to OSFS 114. VFS switch 112 may partially process the file system command and pass the result to the OSFS 114. For instance, VFS switch 112 may access its own directory cache and inode cache to resolve a name of a file system entity to an inode number corresponding to the file system entity indicated in the file system command. This information can be passed along with the file system command to OSFS 114.

OSFS 114 processes the file system command to generate one or more corresponding object-based operations. For example, OSFS 114 may include multiple file system command-specific handlers configured to generate a group of one or more object-based operations that together perform the file system command. In this manner, OSFS 114 transforms the received file system command into an object-centric file system transaction comprising multiple object-based operations. OSFS 114 determines a set of n object-based operations that implement the file system command using objects rather than file system entities. The object-based operations are defined methods or functions that conform to OBS semantics, for example specifying a key value parameter. OSFS 114 instantiates the object-based operations in accordance with the parameters of the file system command and any other information provided by the VFS switch 112. OSFS 114 forms the file system transaction with the object-based operation instances. OSFS 114 submits the transaction to OSFS cache 116 and may record the transaction into a transaction log (not depicted) which can be replayed if another node takes over for the node (e.g., virtual machine or physical machine) hosting OSFS 114.

To create a file system entity, such as in response to receiving a file system command specifying creation of a file or directory, OSFS 114 determines a new inode number for the file system entity. OSFS 114 may convert the inode number from an integer value to an ASCII value, which could be used as a parameter value in an object-based operation used to form the file system transaction. OSFS 114 instantiates a first object storage operation to create a first object with a first object key derived from the determined inode number of the file system entity and with metadata that indicates attributes of the file system entity. OSFS 114 instantiates a second object storage operation to create a second object with a second object key and with metadata that associates the second object key with the first object key. The second object key includes an inode number of a parent directory of the file system entity and also a name of the file system entity.

As shown in FIG. 1, object storage 120 includes the resultant namespace objects and inode objects that correspond to the depicted hierarchical file system namespace 111. The namespace objects and inode objects result from the commands, operations, and requests that flowed through the software stack. As depicted, each file system entity in the file system namespace 111 has a namespace object and an inode object. For example, the top level directory root is represented by a root inode object IOᵣₒₒₜ that is associated with (pointed to) by a namespace object NSOᵣₒₒₜ. In accordance with the namespace configuration, the inode object IOᵣₒₒₜ is also associated with each of the child directories' (dir1 and dir2) namespace objects. The multiple associations of namespace objects with the inode objects enables a file system client to traverse a namespace in a hierarchical file system like manner, although the OSFS does not actually need to traverse from root to target. The OSFS arrives at a target only from the parent of the target, thus avoiding traversing from root.

OSFS cache 116 attempts to fulfill file system transactions received from OSFS 114 with locally stored data. If a transaction cannot be fulfilled with locally stored data, OSFS cache 116 forwards the object-based operation instances forming the transaction to an object storage adapter (OSA) 117. OSA 117 responds by generating object storage requests corresponding to the operations and which conform to a particular object storage protocol, such as S3.

In response to the requests, object storage 120 provides responses processed by OSA 117 and which propagate back through OBS bridge 118. More specifically, OSFS cache 116 generates a transaction response which is communicated to OSFS 114. OSFS 114 may update the transaction log to remove the transaction corresponding to the transaction response. OSFS 114 also generates a file system command response based on the transaction response, and passes the response back to file system client 102 via VFS switch 112.

In addition to providing file system namespace accessibility in a manner enabling native as well as bridge-enabled access, the described aspects provide namespace portability and concurrency for geo-distributed clients. Along with file data and its associated metadata, object store 120 stores a persistent representation of the namespace via storage of the inode and namespace objects depicted in FIG. 1. This feature enables other, similarly configured OBS bridges to attach/mount to the same backend object store and follow the same schema to access the namespace objects and thus share the same file system with their respective file system clients. The OBS bridge configuration may thus be applied in multi-node (including multi-site) applications in order to simultaneously provide common file system namespaces to multiple clients across multiple sites. Aspects of the disclosure may therefore include grouping multiple OBS bridges in a cluster configuration to establish multiple corresponding NAS gateways.

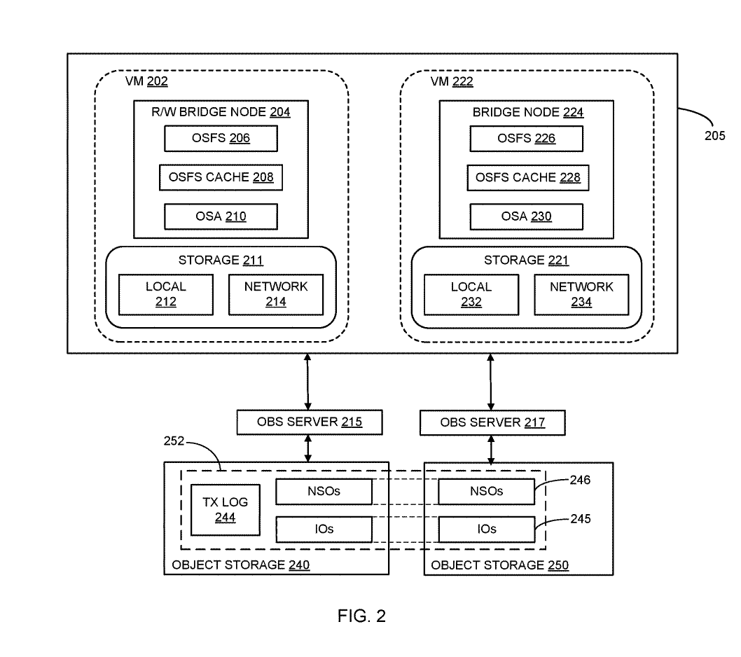

FIG. 2 is a block diagram illustrating an OBS bridge cluster deployment in accordance with an aspect. The depicted deployment includes a bridge cluster 205 comprising a pair of OBS bridge nodes 204 and 224 configured within a corresponding pair of virtual machines (VMs) 202 and 222, respectively. A storage configuration includes object storages 240 and 250 that are each deployed on different site platforms. An object-based namespace container, or bucket, 252 contains inode objects 245 and associated namespace objects 246 that are included within the same bucket 252 that extends between object storages 240 and 250. A pair of OBS servers 215 and 217 process and execute object store transactions to and from object store 240 and object store 250, respectively.

Each of VMs 202 and 222 is configured to include hardware and software resources for implementing a NAS gateway/OBS bridge such as that described with reference to FIG. 1. In addition to the hardware (processors, memory, I/O) and software provisioned for bridge node 204, VM 202 is provisioned with non-volatile storage resources 211, including local platform storage 212 and storage 214 allocated from across a local or wide area network. Bridge node 204 includes an OSFS 206 configured to generate, manage, and/or otherwise access inode objects 245 and corresponding namespace objects 246 that are stored across backend object storages 240 and 250. An OSFS cache 208 persistently stores recently accessed object data and in-flight file system transactions, including object store update operations (e.g., write, create objects) that have not been committed to object stores 240 and/or 250. Bridge node 204 further includes an OSA 210 for interfacing with OBS servers 215 and 217 that directly access storage devices (not depicted) within object storages 240 and 250, respectively. VM node 222 is similarly configured to include the hardware and software devices and functions to implement bridge node 224 as well as being provisioned with non-volatile storage resources 221, including local storage 232 and network accessed storage 234. Bridge node 224 includes an OSFS 226 configured to generate and access inode objects 245 and namespace objects 246. An OSFS cache 228 persistently stores recently accessed object data and in-flight file system transactions. Bridge node 224 further includes an OSA 230 for interfacing with OBS servers 215 and 217.

An OBS bridge cluster, such as bridge cluster 205, may be created administratively such as by issuing a Create cluster command from a properly configured VM such as 202 or 222. Two nodes are depicted for the purpose of clarity, but other nodes may be added or removed from bridge cluster 205 such as by issuing or receiving Join or Leave commands administratively. Bridge cluster 205 may operate in a “data cluster” configuration in which each of nodes 204 and 224 may concurrently and independently query (e.g., read) object storage backed file system data within object storages 240 and 250. In the data cluster configuration, one of the nodes is configured as a Read/Write node with update access to create, write to, or otherwise modify namespace and inode objects 246 and 245. The Read/Write node may consequently have exclusive access to a transaction log 244 which provides a persistent view of in-flight transactions. Transaction log 244 may persist namespace only or namespace and data included within in-flight file system transactions. While being members of the same bridge cluster 205, there may be minimal direct interaction between the nodes 202 and 222 if the cluster is configured to provide managed, but substantially independent multi-client access to a given object storage container/bucket.

In an aspect, bridge node 204 may be configured as the Read/Write node and bridge node 224 as a Read-Only node. Each node has its own partially independent view of the state of the file system namespace via the transactions and objects recorded in its respective OSFS cache. Configured in this manner, bridge node 204 implements and is immediately aware of all pending namespace state changes while bridge node 224 is exposed to such changes via the backend storages 240 and 250 only after the changes are replicated by bridge node 204 from its OSFS cache 208. For example, in response to bridge node 204 receiving a file rename file system command, OSFS 206 will instantiate one or more object-based operations to form a file system transaction that implements the command in the object namespace. OSFS cache 208 records the object-based operations in an intent log (not depicted) within non-volatile storage 211 where the operations remain until an asynchronous writer service replicates the file system transaction to OSA 210 which, in cooperation with OBS servers 215 and/or 217 executes the object-based operations with respect to the namespace and/or inode objects within object stores 240 and/or 250. Prior to replication and effective execution of the file system transaction, bridge node 224 remains unaware of and unable to determine that the namespace change has occurred. This eventual consistency model is typical of shared object storage systems but not of shared file system storage in which locking or other concurrency mechanisms are used to ensure a consistent view of the hierarchical file system structure.

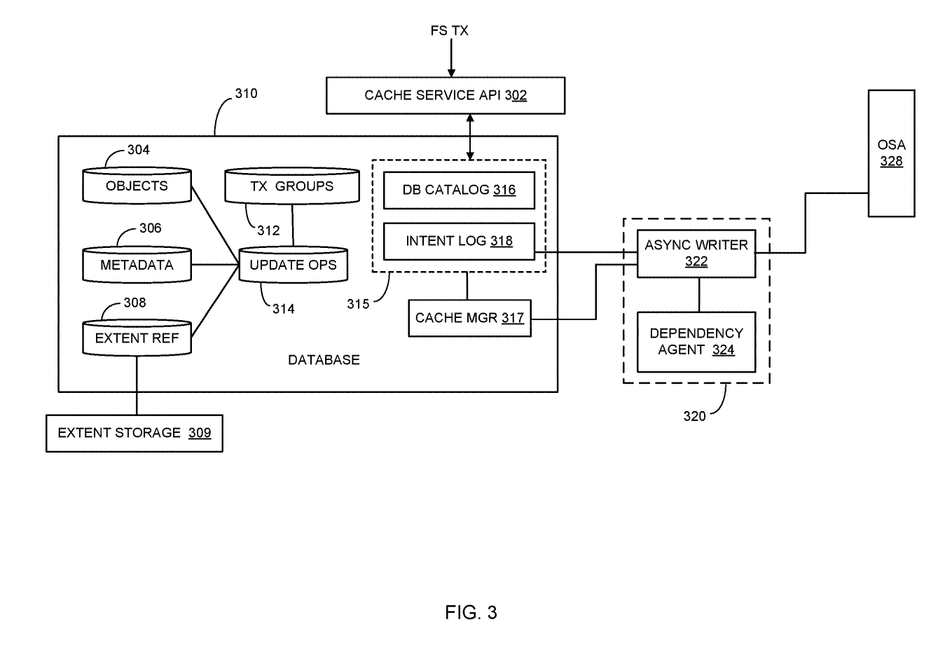

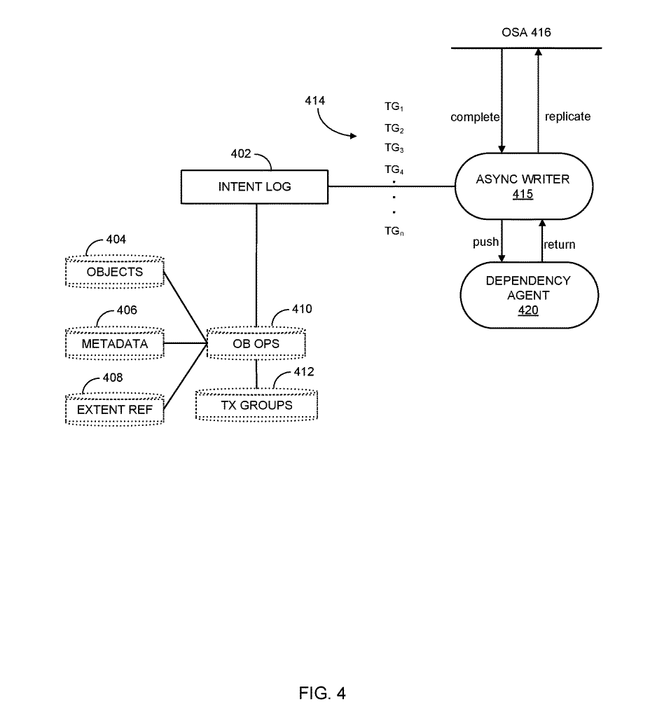

FIGS. 3 and 4 depict OBS bridge functionality such as may be deployed by Read/Write bridge node 204 and/or Read-Only node 224 to optimize I/O responsiveness to file system commands while maintaining coherence in the file system view of object-based storage. The disclosed examples provide a local read and write-back cache in which update transactions and associated data are stored in persistent storage for failure recoverability. In another aspect, concurrency for read-only nodes is a tunable metric that can be set and adjusted by a read-cache time to live (TTL) parameter in conjunction with a write-back cache consistency point (CP) interval. In another aspect, a replication engine increases effective replication throughput while preventing modifications (updates) to namespace and/or inode objects from causing an inconsistent or otherwise corrupted file system view of object storage.

An OSFS cache is a subsystem of an OBS bridge that is operably configured between an OSFS and an OSA. Among the functions of the OSFS cache is to provide object-centric services to its OSFS client, enabling object-backed file system transactions to be processed with improved I/O performance compared with traditional object storage. The OSFS cache employs an intent log and an asynchronous writer (lazy writer) for propagating object-centric file system update transactions to backend object store.

FIG. 3 is a block diagram illustrating an OSFS cache. The OSFS cache comprises a database 310 that provides persistent storage of and accessibility to objects and object-based operation requests (object-based operations). Database 310 is deployed using the general data storage services of a local file system and is maintained in non-volatile storage (e.g., disk, SSD, NVRAM, etc.) to prevent loss of data in the event of a system failure. The file system may be, for example, a Linux® file system. Database 310 receives each file system transaction as a set of one or more object-based operations that are generated by the OSFS. The transactions are received by a cache service API layer 302 which serves as the client interface front-end for the OSFS cache. Service API layer 302 may wrap multiple object-based operations designated by the OSFS as belonging to a same file system transaction group (transaction group) into an individually cacheable operation unit.

Operations forming transaction groups are submitted to a persistence layer 315, which comprises a database catalog 316 and an intent log writer 318. Persistence layer 315 maintains state information for the OSFS cache by mapping objects and object relationships onto their corresponding database entries. Intent log writer 318 identifies those transaction groups consisting of one or more object-based operations that update object storage (e.g., mkdir). Intent log writer 318 records and provides ordering/sequencing by which update-type transaction groups are to be replicated. Catalog 316 tracks all data and metadata within the OSFS cache, effectively serving as a key-based index. For example, service API 302 uses catalog 316 to determine if a query operation can be fulfilled locally, or must be fulfilled from backend object storage. Intent log writer 318 uses catalog 316 to locally store update transactions and corresponding operations and associated data, thus providing query access to the intent log data.

Intent log writer 318 is the mechanism through which update transaction groups are preserved to an intent log for eventual replication to backend object storage. When an update transaction group is submitted to the OSFS cache, intent log writer 318 persists the transaction group and its constituent operations within database 310 before the originating file system command is confirmed. In the case of a data Write operation, intent log writer 318 also persists the user data to extent storage 309 via extents reference table 308 before the file system command is confirmed. Central to the function of intent log writer 318 and the intent log that it generates is the notion of a file system transaction group (transaction group). A transaction group consists of one or more object-based operations that are processed atomically in an OSFS-specified order. In response to identifying the transaction group or one of the transaction group's operations as an update, intent log writer 318 executes a database transaction to record the transaction group and the components of each of the constituent operations in corresponding tables of database 310. The recorded transaction is replicated to an OSA 328 and executed with respect to an object store at a future point. The intent log generated by intent log writer 318 persists the updates in the chronological order in which they were received from the OSFS. This enables the OSFS cache's write-back mechanism (depicted as asynchronous writer 322) to preserve the original insertion order as it replicates to backend object storage. In this manner, intent log writer 318 generates chronologically sequenced records of each update transaction group that has not yet been replicated to backend object storage.

Each record within the intent log is constructed to include two types of information: an object-based operation such as CreateObject, and the transaction group to which to which the operation belongs. An object-based operation includes a named object, or key, as the target of the operation. A transaction group describes a set of one or more operations that are to be processed as a single transaction work unit (i.e., processed atomically) when executed with respect to backend object storage. The records generated by intent log writer 318 are self-describing, including the operations and data to be written, thus enabling recovery of the data as well as the object storage state via replay of the operations. Intent log writer 318 uses catalog 316 to reference file data that may be stored in extent storage 309 that is managed by the local file system. For example, if an update operation includes user data (i.e., object data content), then the data may be committed (if not already committed) to extent storage 309.

Database 310 includes several tables that, in conjunction with catalog 316, associatively store related data utilized for transaction persistence and replication. Among these are an update operations table 314 in which object-based operations are recorded and a transaction groups table 312 in which transaction group identifiers are recorded in association with corresponding update operations stored in table 314. The depicted database tables further include an objects table 304, a metadata table 306, and an extents reference table 308. Objects table 304 stores objects including namespace objects that are identified in object-based operations. Metadata table 306 stores the file system metadata associated with inode objects. Extents reference table 308 includes pointers by which catalog 316 and intent log 318 can locate storage extents containing user data within the local file system. The records within the intent log may be formed from information contained in update operations table 314 and transaction groups table 312 as well as information from one or more of objects table 304, metadata table 306, and extents reference table 308. The database tables may be used in various combinations in response to update or query (e.g., read) operation requests. For example, in response to an object metadata read request, catalog 316 would jointly reference object table 304 and metadata table 306.

The depicted OSFS cache further includes a cache manager 317 that monitors the storage availability of the underlying storage device and provides corresponding cache management service such as garbage collection. Cache manager 317 interacts with a replication engine 320 during transaction replication by signaling a high pressure condition to replication engine 320 which responds by replicating at a higher rate to make more data within the OSFS cache available for eviction.

The OSFS cache further includes a replication engine 320 that comprises an asynchronous (async) writer 322 and a dependency agent 324. Replication engine 320 interacts with an OSA 328 to replicate (replay, commit) the intent log's object based operations content to backend object storage. Replication is executed, in part, based on the insertion order in which intent log writer 318 receives and records transactions. The order of replication may also be optimized depending on the nature of the operations constituting the transaction groups and dependencies, including namespace dependencies, between the transaction groups. Execution of replication engine 320 may generally comply with a periodic consistency point that may be administratively determined or may be dynamically adjusted based on operating conditions. In an aspect, the high-level sequence of replication engine 320 execution begins with async writer 322 reading a transaction group comprising one or more object-based operations from the intent log. Async writer 322 submits the object-based operations in a pre-specified transaction group order to OSA 328 and waits for a response from backend object storage. On confirmation of success, async writer 322 removes the transaction group and corresponding operations from the intent log. On indication that any of the operations failed, the async writer 322 may log the failure to the intent log 318 and does not remove the transaction group from the log. In this manner, once a transaction group has been recorded by intent log writer 318, it is removed only after is has been replicated to backend object storage.

Maintaining general chronological order is required to prevent file system namespace corruption. However, some modifications to the serialized sequencing of transaction group replication may improve I/O responsiveness and reduce network traffic levels while maintaining namespace integrity. In an aspect, async writer 322 interacts with dependency agent 324 to increase replication throughput by altering the otherwise serialized sequencing. Dependency agent 324 determines relationships, such as namespace dependencies, between transaction groups to determine whether and in what manner to modify the otherwise serially chronological sequencing of transaction group replication. For example, if dependency agent 324 detects that chronologically consecutive transactions groups, TGₙ and TGₙ₊₁, do not share a namespace dependency (i.e., are orthogonal), dependency agent 324 may provide both action groups for concurrent replication by async writer 322. As another example, if dependency agent 324 detects that multiple transaction groups are writes to the same inode object, the transaction groups may be coalesced into a single write operation to backend storage.

The intent log within database 310 is recorded in non-volatile storage media in and committed atomically in order to ensure namespace consistency. However, if the non-volatile storage device failure occurs during attempted atomic commitment of a transaction group that includes one or more object-based operations that modify the namespace, the object store namespace may be left inconsistent. In some embodiments, the replicating/committing of the transaction groups is modified to account for potential namespace modifications effectuated by one or more of the constituent object-based operations. In some embodiments, the components of the OSFS cache may determine, for each transaction group, whether the transaction group modifies the file system namespace. For example, a transaction group corresponding to a mkdir file system command is implemented as the following set of object-based operations: an update-parent-object with metadata; a create child inode object; and a create namespace object. The creation of the inode object and the creation of the namespace object each modify the file system namespace.

In an embodiment, intent log writer 318 may initially determine whether the transaction group modifies the file system namespace and may identify each transaction group accordingly within a namespace operations table 313. For example, intent log write 318 may be configured to recognize specified types of object-based operations as modifying an object namespace. In response to determining that a transaction group modifies the file system namespace, intent log writer 318 may record a namespace modifier flag in association with one or more transaction groups within namespace operations table 313.

Replication engine 320 may be configured to process namespace modifier transaction during replication/commitment. During replication/commitment of the object-based operations to the backend object store, the replication engine 320 may determine for each of the transaction groups, whether the group modifies a file system namespace. In an embodiment, the determination by replication engine 320 may be based on a flag or other information from the intent log. Alternately, replication engine 320 may be configured to identify object-based operations that modify the file system namespace and may make the determination based on one or more such identifications. For each transaction group that is determined to modify the file system namespace, and prior to committing object-based operations of the set, replication engine 320 generates a recovery-begin object that describes the transaction group. For instance, the recovery-begin object may comprise, at least in part, a copy of the entire set of object-based operations in the transaction group. Replication engine assigns a standardized object name (i.e., key name) such as RECOVERY BEGIN to the recovery-begin object. Replication engine 320, in cooperation with OSA 328, stores the recovery-begin object to the backend object store prior to committing (i.e., executing) any of the object-based operations. In this manner, if the non-volatile storage device in which the intent log is stored fails during commitment of the individual object-based operations, the recovery-begin object is available within backend storage so that the object namespace can be accurately restored upon system restart.

Having stored the recovery-begin object, replication engine 320 begins executing each of the object-based operations in the transaction group. In response to all of the object-based operations in the group being executed, replication engine issues an object remove command to OSA 328 to remove the recovery-begin object from the backend object store. In this manner, in response to a system start or restart, a disaster recovery cycle may commence with an OSFS bridge configured to search the object store key-space for a specified object name such as RECOVERY BEGIN. For each located instance of the specified object name, the OSFS bridge executes the corresponding set of object-based operations. In this manner, the object namespace consistency is restored.

FIG. 4 is a block diagram illustrating components of an OSFS cache for replicating updates to an OBS. An intent log writer 402 persistently records and maintains intent log records in which sets of one or more object-based operations form transaction groups. Each intent log record includes data distributed among one or more database tables. For instance, an object-based operations table 410 stores the operations and a transaction groups table 412 stores transaction group information including associations to operations within table 410. Relationally associated with operations table 410 are an objects table 404, a metadata table 406, and an extents reference table 408. Corresponding data may be read from one or more of tables 404, 406, and 408 when accessing (reading) the operations contained in table 410 and referenced by table 412.

An asynchronous (async) writer 415 periodically, or in response to messages from a cache manager, commences a replication sequence that begins with async writer 415 reading a series of transaction groups 414 from intent log 402. The sequence of the depicted series of transaction groups 414 is determined by the order in which they were received and recorded by intent log 402. In combination, the recording by intent log 402 and subsequent replication by asynchronous writer 415 generally follow a FIFO queuing schema which enables a lagging but consistent file system namespace view for other bridge nodes that share the same object store bucket. While FIFO replication sequencing generally applies as the initial sequence schema, async writer 415 may inter-operate with a dependency agent 420 to modify the otherwise entirely serialized replication to improve performance. The depicted example may employ at least two replication sequence optimizations.

One sequence optimization may be utilized for transaction groups determined to apply to objects that are different (not the same inode object) and are contained in different parent directories. Such transaction groups and/or their underlying object-based operations may be considered mutually orthogonal. The other replication sequence optimization applies to transaction groups that comprise writes to the same inode object. To implement these optimizations, async writer 415 reads out the series of transaction groups 414 and may optimize the transaction groups for replication optimization. Async writer 415 then pushes the series of transaction groups to dependency agent 420. Dependency agent 420 identifies the transaction groups and their corresponding member operations to determine which, if any, of the replication sequence optimizations can be applied. After sending (pushing) the transaction groups, async writer 415 queries dependency agent 420 for transaction groups that are ready to be replicated to backend object storage via an OSA 416.

For orthogonality-based optimization, dependency agent 420 reads namespace object data for namespace objects identified in the object-based operations. Dependency agent 420 compares the namespace object data for operations contained within different transaction groups to determine, for instance, whether a dependency exists between one or more operations in one transaction group and one or more operations in another transaction group. In response to determining that a dependency exists between a pair of consecutively sequenced transaction groups (e.g., TG₁ and TG₂), dependency agent 420 stages the originally preceding group to remain sequenced for replication prior to replication of the originally subsequent group. If no dependencies are found to exist between TG₁ and TG₂, dependency agent 420 stages TG₁ and TG₂ to be replicated concurrently by async writer 415.

For multi-write coalescence optimization, dependency agent 420 reads inode object keys to identify transaction groups comprising write operations that identify the same target inode object. Dependency agent 420 coalesces all such transaction groups for which there are no sequentially intermediate transaction groups. For sets of one or more writes to the same inode object that have intervening transaction groups, dependency agent 420 determines whether namespace dependencies exist between the write(s) to the same inode object and the intervening transaction groups. For instance, if TG₁, TG₂, and TG₄ each comprise a write operation to the same inode object, dependency agent 420 will coalesce the underlying write operations in TG₁ and TG₂ into a single write operation because they are sequenced consecutively (no intermediate transaction group). To determine whether TG₄ can be coalesced with TG₁ and TG₂, dependency graph 420 determines whether the intermediate TG₃ comprises operations that introduce a dependency with respect to TG₄. Extending the example, assume TG₁, TG₂, and TG₄ are each writes to the same file1 inode object which is contained within a dir1 object. In response to determining that TG₃ contains a rename operation renaming dir1 to dir2, dependency agent 420 will not coalesce TG₄ with TG₁ and TG₂ since doing so will cause a namespace inconsistency.

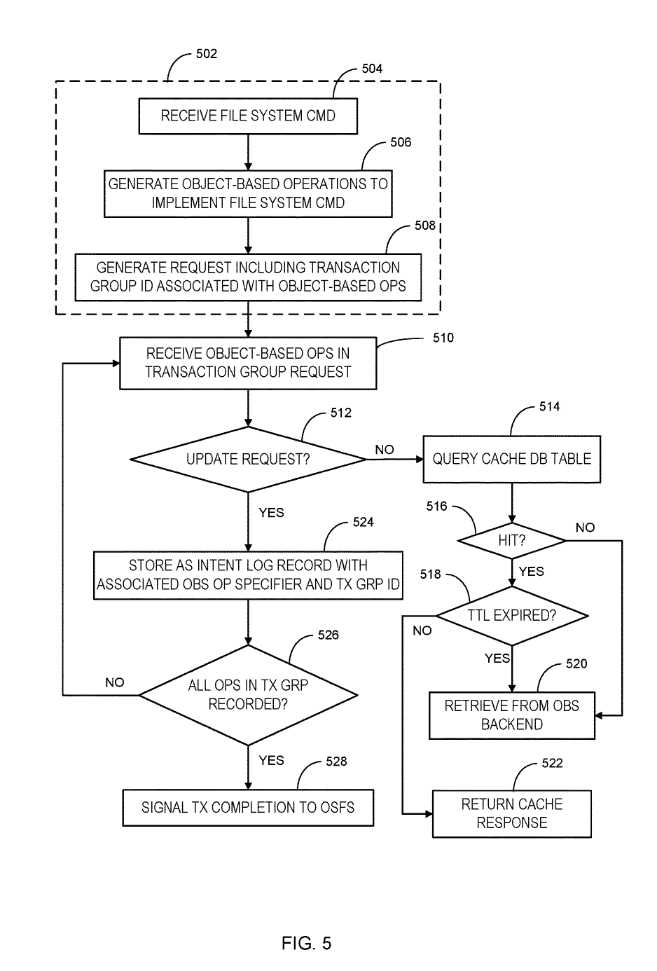

FIG. 5 is a flow diagram illustrating operations and functions for processing file system commands. The process includes a series of operations 502 performed by an OSFS, beginning as shown at block 504 with the OSFS receiving a file system command from a file system client. The file system command may be a query such as a read command to retrieve content from the object store. The command may also be an update command such as mkdir that results in a modification to the file system namespace, or a write that modifies an object. At block 506, the OSFS generates one or more object-based operations that, as a set, will implement the file system command within object-based storage. For a mkdir file system command, the OSFS may generate a modify object metadata operation, a create inode object operation, and a create namespace object operation. In this example, the OSFS forms a transaction group having a reference ID and comprising the three operations. At block 508, the OSFS generates a transaction request that includes the three operations and identifies the three operations as mutually associated via the reference ID. In addition, the request specifies the order in which the operations are to be committed (replicated) to backend object storage. Continuing with the mkdir example, the OSFS includes a sequence specifier in the request that specifies that the modify metadata is to be replicated first, followed by the create inode object, which is in turn followed by replication of the create namespace object.

An OSFS cache, such as those previously described, receives the object-based operations within the transaction request (block 510). The OSFS cache processes the content of the request to determine the nature of the member operations. In the depicted example, the OSFS cache determines whether the transaction group as a whole or one or more of the member operations will result in a modification to the object store (i.e., whether the transaction group operations include update operations). The OSFS cache may determine whether the transaction request is an update request by reading one or more of the member operations. In another aspect, the OSFS cache may read a flag or another transaction request indicator such as may be encoded in the transaction group ID to determine whether the transaction request and/or any of its member operations will modify the object store.

In response to determining at block 512 that the request is a non-update request (e.g., a read), control passes to block 514 and the OSFS cache queries a database catalog or table to determine whether the request can be satisfied from locally stored data. In response to determining that the requested data is not locally cached at block 516 (i.e., a miss), control passes to block 520 with the OSFS forwarding the read request for retrieval from the backend object store. In response to detecting that the requested data is locally cached at block 516 (i.e., hit), the OSFS cache determines at block 518 whether a time-to-live (TTL) period has expired for the requested data. In response to the detecting that the TTL has expired, control passes to block 520 with the OSFS forwarding the read request to the backend object store. In response to detecting that the TTL has not expired, the OSFS returns the requested data from the local cache database to the OSFS at block 522.

Returning to block 512, in response to determining that the request is an update request (e.g., a write), the OSFS cache records the member operations in intent log records within the database at block 524. In an aspect, the OSFS cache records the member transactions in the order specified by the transaction request and/or in the order in which the operations were received in the single or multi-part transaction request. The order in which the operations are recorded may or may not be the same as the order in which the operations are eventually replicated. In an aspect in which the recording order does not determine replication order, the replication order may be determined based on a replication order encoded as part of the transaction request. The replication order is a serially sequential replication order that may be determinable by the OSFS cache following recordation of the operations. In addition to preserving the recording/replication order of the member operations, the OSFS cache records each of the operations in intent log records that associate the operations with the corresponding transaction group ID.

In an aspect in which the member operations are serially recorded within the intent log, at block 526 the OSFS cache follows storage of each operation with a determination of whether all of the member operations have been recorded. In response to determining that unrecorded operations remain, control passes back to block 510 with the OSFS cache receiving the next operation for recordation processing. In response to determining that all member operations have been recorded, the OSFS cache signals, by response message or otherwise, to the OSFS at block 528 that the requested transaction that was generated from a file system command has been completed. The OSFS may forward the completion message back to the file system client.

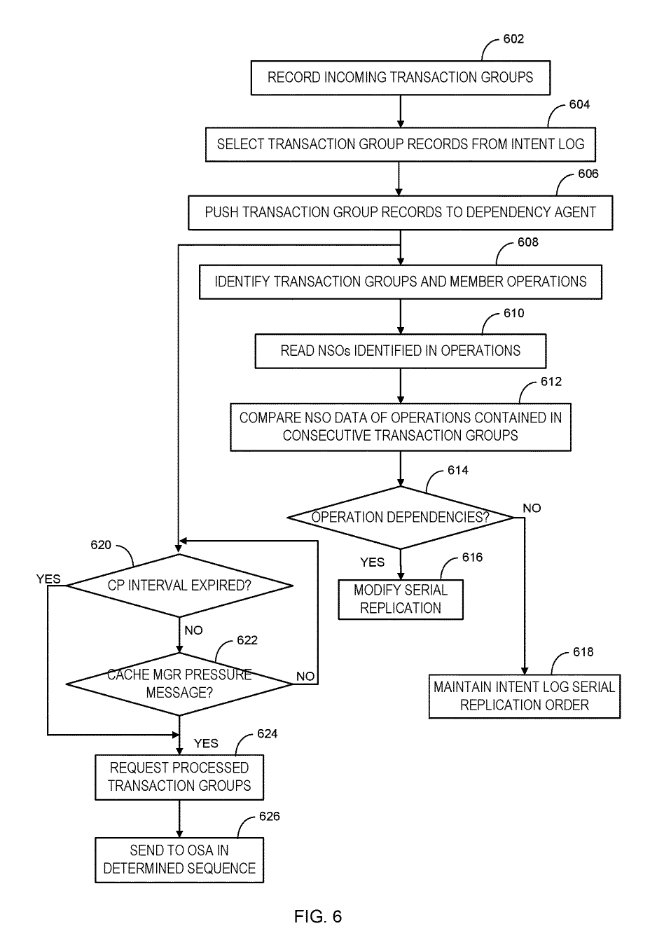

FIG. 6 is a flow diagram depicting operations and functions performed by an OSFS cache that includes a replication engine for replicating updates to an OBS backend. The replication engine includes an asynchronous writer (async writer) that is configured to implement lazy write-backs of update operations that are recorded to an intent log. In the background, at block 602, an intent log within the OSFS cache continuously records sets of one or more object-based operations that form transaction groups. The async writer selects a series of transaction group records from the intent log at block 604. The transaction group records include object-based operations such as read, write, and copy operations that are categorized within the records as belonging to a particular transaction group. The number of transaction group records selected (read) from the intent log may be a pre-specified metric or may be determined by operating conditions such as recent replication throughput, cache occupancy pressure, etc. At block 606 the async writer pushes the records to a dependency agent that is programmed or otherwise configured to identify whether dependencies, such as namespace object dependencies, exist between operations that are members of different transaction groups. At block 608 the dependency agent identifies transaction groups so that the dependency agent can determine the respective memberships of operations within the transaction groups. At block 610, the dependency agent reads the data of one or more namespace objects that are identified in one or more of the object-based operations. The namespace object data may include the namespace object content (i.e., the namespace object key comprising the inode ID of a parent inode and a file system name) and it may also include the namespace object metadata (i.e., the namespace object key pointing to the corresponding inode key).

At block 612, the dependency agent compares the namespace object data of operations belonging to different transaction groups. The comparison may include determining whether one or more namespace keys contained in a first namespace object identified by a first operation match or bear another logical association with one or more namespace keys of a second namespace object identified by a second operation. For instance, consider a pair of transaction groups, TG1 and TG2, that were received and recorded by the intent log such that TG1 precedes TG2 in consecutive sequential order. Having read the namespace objects identified in member operations of both TG1 and TG2, the dependency agent cross compares the namespace object data between the groups to detect dependencies that would result in a file system namespace collision if TG1 and TG2 are not executed sequentially. Such file system namespace collisions may not impact the Read/Write bridge node hosting the async writer but it may result in a corrupted file system namespace view for other nodes within the same cluster.

The dependency agent and async writer sequence or re-sequence the transaction groups based on whether dependencies were detected. In response to detecting a namespace dependency between consecutively sequenced transaction groups at block 614, the dependency agent and async writer maintain the same sequence order as was recorded in the intent log for replication of the respective transaction groups (block 618). In response to determining that no dependencies exist between the transaction groups, the otherwise consecutively sequenced groups are sent for replication concurrently (block 616).

While the dependency continuously processes received transaction group records, the async writer may be configured to trigger replication sequences at consistency point (CP) intervals (block 620) and/or be configured to trigger replication based on operational conditions such as cache occupancy pressure (block 622). The CP interval may be coordinated with TTL periods set by other OBS bridge nodes, such as reader nodes. The async writer may be configured such that the CP is the maximum period that the async writer will wait before commencing the next replication sequence. In this manner, and as depicted with reference to blocks 620 and 622, the async writer monitors for CP expiration and in the meantime may commence a replication sequence if triggered by a cache occupancy message such as may be sent by a cache manager. In response to either trigger, control passes to block 624 with the async writer retrieving from the dependency agent transaction groups that have been sequenced (serially and/or optimally grouped or coalesced). The async writer sends the retrieved transaction groups in the determined sequence to the OSA (block 626).

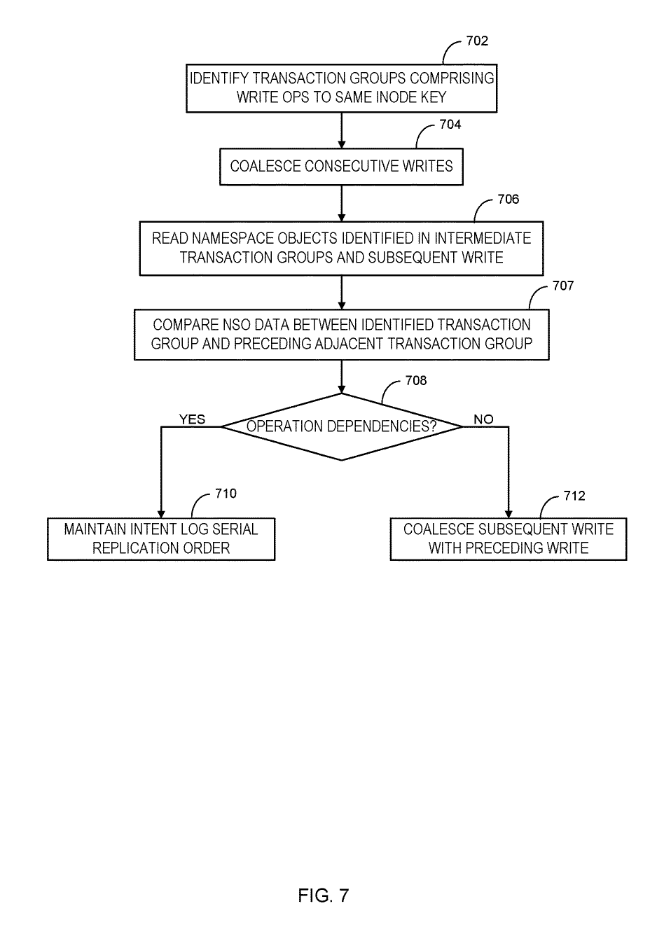

In addition to or in place of the functions depicted and described with reference to blocks 610, 612, 614, 616, and 618, the dependency agent may optimize replication efficiency by coalescing write requests. FIG. 7 is a flow diagram illustrating operations and functions that may be performed by a dependency agent for coalescing write operations. Replication optimization begins with an async writer reading and pushing a series of transaction groups to a dependency agent. At block 702, the dependency agent identifies transaction groups that comprise a write to the same inode object. The dependency agent may perform the identification by reading and comparing inode object keys for each write operation within the respective transaction groups. At block 704, the dependency agent coalesces sets of two or more of the identified transaction groups that are sequenced consecutively. For instance, consider a serially sequential set of eight transaction groups, TGₙ through TGₙ₊₇, in which TGₙ, TGₙ₊₂, TGₙ₊₃, and TGₙ₊₄, are comprise write operations to the same inode object. In this case, at block 704, the dependency agent coalesces TGₙ₊₂, TGₙ₊₃, and TGₙ₊₄ since they are mutually consecutive.

At block 706, for the remaining identified transaction groups, the dependency agent reads namespace objects identified in transaction groups that immediately precede one of the transaction groups that were identified at block 702 (TGₙ₊₁ in the example). The dependency agent also reads data for the namespace object(s) identified in the consecutively subsequent write transaction (TGₙ₊₂ in the example). At block 707, the dependency graph compares the namespace object data between the identified transaction group and one or more preceding and consecutively adjacent transaction groups that were not identified as comprising writes to the inode object. In response to detecting dependencies, the intent log serial order is maintained and the write operation is not coalesced with preceding writes to the same inode object (block 710). In response to determining that no dependencies exist between the write operation and all preceding and consecutively adjacent transaction groups, the write operation/transaction is coalesced into the preceding writes to the same inode object. For instance, and continuing with the preceding example, if no namespace dependencies are found between TGₙ₊₁ and TGₙ₊₂, the dependency graph will coalesce TGₙ with TGₙ₊₂, TGₙ₊₃, and TGₙ₊₄ to form a single write operation.

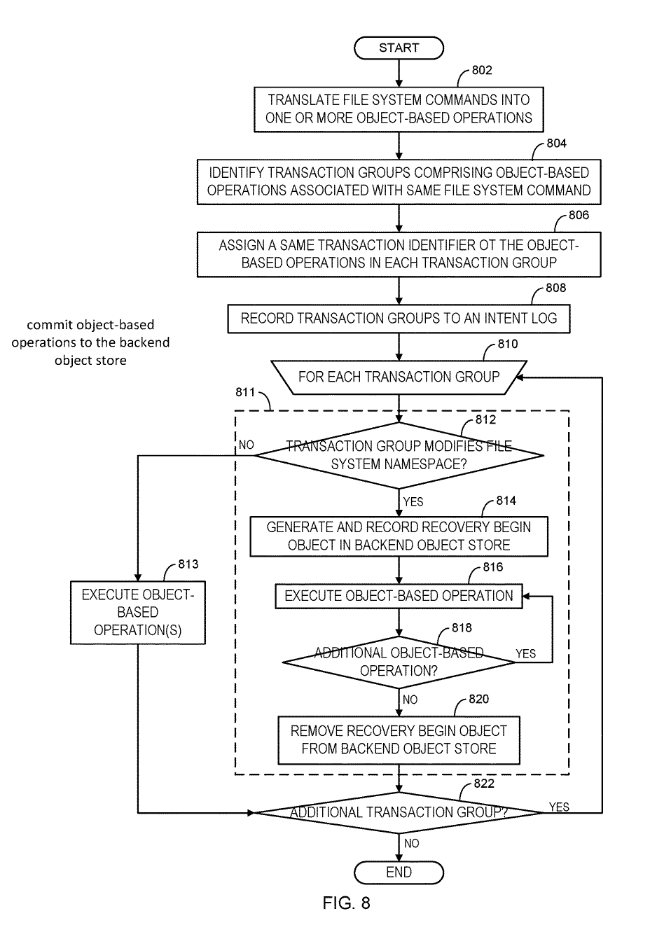

FIG. 8 is a flow diagram depicting operations and functions for ensuring atomicity of transaction group commitment to backend object store in accordance with some embodiments. The operations and functions depicted in FIG. 8 may be performed by one or more of the systems, devices, and components described with reference to FIGS. 1-3. The process begins as shown at block 802 with an OSFS translating file system commands into object-based operations. For instance, the OSFS may receive one or more file system commands including a make directory command, mkdir. For each of the received file system commands, the OSFS generates one or more corresponding object-based operations.

Continuing with the example, the OSFS generates a write metadata operation, a create inode object operation, and a create namespace object operation, all corresponding to the mkdir command.

At block 804, and as part of the file command translation process, the OSFS identifies the groups of object-based operations as belong to respective transaction groups and associates transaction group identifiers accordingly (block 806). Each of the groups/sets of object-based operations may be associated with a transaction identifier each expressly or inherently, such as by being mutually associated. At block 808, one or more components of an OSFS cache, such as an intent log writer, records the transaction groups in an intent log such as the intent log described with reference to FIGS. 1-3.

As shown at block 810 and superblock 811, each of the transaction groups enters a commit phase in which components of the OSFS cache, in cooperation with an OSA interface, commit object-based operations to the backend object store. The OSFS cache first determines whether the transaction group includes one or more object-based operations that result in a file system namespace modification (block 812). In response to determining that the transaction group does not modify the namespace, the OSFS cache commits/executes the one or more object-based operations to backend object storage (block 813). In response to determining that the transaction group modifies the namespace, the OSFS cache generates a begin recovery object that describes the group of object-based operations within the transaction group (block 814). Also, and prior to commitment of any of the constituent object-based operations, the OSFS records the begin recovery object within the backend storage.

At block 816, the OSFS cache components including an asynchronous writer, begin replicating/committing the object-based operations of the transaction group to backend storage. The replication/commitment continues until, at block 818, the OSFS cache determines that all object-based operations for the transaction group have been committed and the OSFS cache removes (e.g., deletes) the begin recovery object from the backend object store (block 820). The process of committing transaction groups may continue (block 822) with control passing back to block 810 until the process ends.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality provided as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

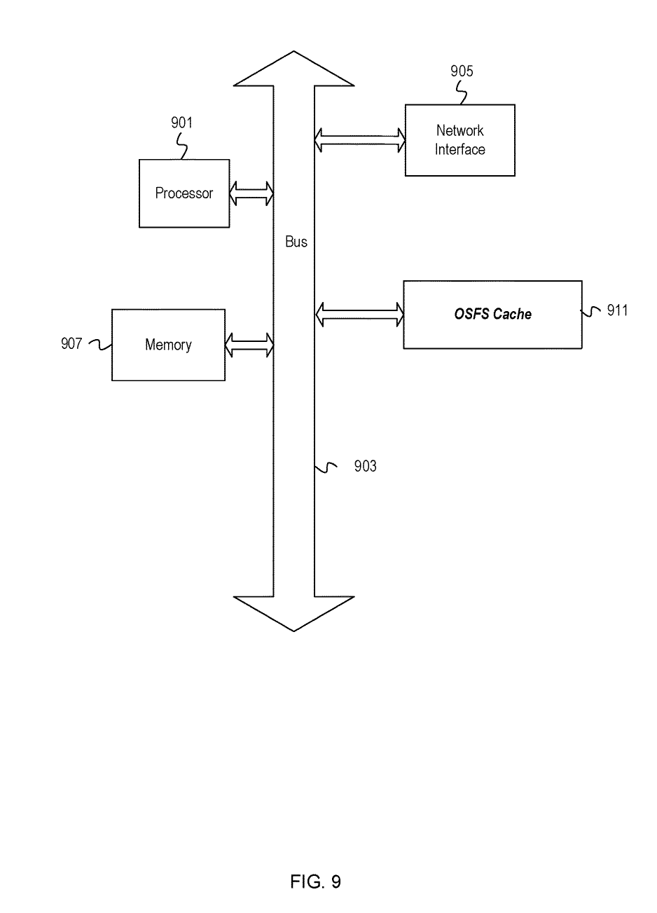

FIG. 9 depicts an example computer system with an OSFS cache. The computer system includes a processor unit 901 (possibly including multiple processors, multiple cores, multiple nodes, and/or implementing multi-threading, etc.). The computer system includes memory 907. The memory 907 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 903 (e.g., PCI, ISA, PCI-Express, HyperTransport® bus, InfiniBand® bus, NuBus, etc.) and a network interface 905 (e.g., a Fiber Channel interface, an Ethernet interface, an internet small computer system interface, SONET interface, wireless interface, etc.). The system also includes an OSFS cache 911. The OSFS cache 911 persistently stores operations, transactions, and data for servicing an OSFS client. Any one of the previously described functionalities may be partially (or entirely) implemented in hardware and/or on the processor unit 901. For example, the functionality may be implemented with an application specific integrated circuit, in logic implemented in the processor unit 901, in a co-processor on a peripheral device or card, etc. Further, realizations may include fewer or additional components not illustrated in FIG. 9 (e.g., video cards, audio cards, additional network interfaces, peripheral devices, etc.). The processor unit 901 and the network interface 905 are coupled to the bus 903. Although illustrated as being coupled to the bus 903, the memory 907 may be coupled to the processor unit 901.

While the aspects of the disclosure are described with reference to various implementations and exploitations, it will be understood that these aspects are illustrative and that the scope of the claims is not limited to them. In general, techniques for an object storage backed file system that efficiently manipulates namespace as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality shown as separate components in the example configurations may be implemented as a combined structure or component. Similarly, structures and functionality shown as a single component may be implemented as separate components. These and other variations, modifications, additions, and improvements may fall within the scope of the disclosure.

What is claimed is:

1. A method for replicating object-based operations generated based on file system commands, said method comprising:
translating each of a plurality of file system commands into a respective transaction group of one or more object-based operations;
assigning a same transaction identifier to the object-based operations in each of the transaction groups;
recording the transaction groups to an intent log that buffers the transaction groups prior to commitment of the object-based operations to a backend object store; and
committing the object-based operations to the backend object store, wherein said committing includes,
determining for each of the transaction groups, whether the transaction group modifies a file system namespace; and
for each transaction group that is determined to modify the file system namespace, and prior to committing object-based operations of the transaction group,
generating a recovery-begin object that describes the transaction group; and
storing the recovery-begin object to the backend object store.

2. The method of claim 1, wherein said generating a recovery-begin object comprises generating a recovery-begin object that includes all object-based operations within the transaction group.

3. The method of claim 1, wherein said committing further includes:
executing each of the object-based operations in the transaction group; and
in response to all of the object-based operations in the transaction group being executed, removing the recovery-begin object from the backend object store.

4. The method of claim 3, further comprising:
in response to a system restart event, identifying one or more recovery-begin objects within the backend object store; and
for each identified recovery-begin object, executing each of the object-based operations contained in the recovery-begin object.

5. The method of claim 4, wherein said generating a recovery-begin object comprises assigning a specified object name to the recovery-begin object, and wherein said identifying one or more recovery-begin objects comprises searching an object container using the specified object name as a search key.

6. The method of claim 1, further comprising:
reading object data associated with at least one of the object-based operations;
determining operation dependencies among the transaction groups based on the object data;
sequencing the transaction groups based on the determined operation dependencies; and
replicating the object-based operations in an order determined by said sequencing.

7. The method of claim 6, wherein said reading object data associated with at least one of the object-based operations includes reading namespace object data associated with at least one of the object-based operations, and wherein said determining operation dependencies further comprises:
reading data of a first namespace object identified in an object-based operation of a first transaction group;
reading data of a second namespace object identified in an object-based operation of a second transaction group;
comparing the data of the first namespace object with the data of the second namespace object; and
determining whether an operation dependency exists between the first transaction group and the second transaction group based on said comparing.

8. One or non-transitory more machine-readable media having program code for replicating object-based operations generated based on file system commands stored therein, the program code to:
translate each of a plurality of file system commands into a respective transaction group of one or more object-based operations;
assign a same transaction identifier to the object-based operations in each of the transaction groups;
record the transaction groups to an intent log that buffers the transaction groups prior to commitment of the object-based operations to a backend object store; and
commit the object-based operations to the backend object store, wherein the program code to commit includes program code to,
determine for each of the transaction groups, whether the transaction group modifies a file system namespace; and
for each transaction group that is determined to modify the file system namespace, and prior to committing object-based operations of the transaction group,
generate a recovery-begin object that describes the transaction group; and
store the recovery-begin object to the backend object store.

9. The machine-readable media of claim 8, wherein the program code to generate a recovery-begin object comprises program code to generate a recovery-begin object that includes all object-based operations within the transaction group.

10. The machine-readable media of claim 8, wherein the program code to commit further includes program code to:
execute each of the object-based operations in the transaction group; and
in response to all of the object-based operations in the transaction group being executed, remove the recovery-begin object from the backend object store.

11. The machine-readable media of claim 10, further comprising program code to:
in response to a system restart event, identify one or more recovery-begin objects within the backend object store; and
for each identified recovery-begin object, execute each of the object-based operations contained in the recovery-begin object.

12. The machine-readable media of claim 11, wherein the program code to generate a recovery-begin object comprises program code to assign a specified object name to the recovery-begin object, and wherein the program code to identify one or more recovery-begin objects comprises program code to search an object container using the specified object name as a search key.

13. The machine-readable media of claim 8, further comprising program code to:
read object data associated with at least one of the object-based operations;
determine operation dependencies among the transaction groups based on the object data;
sequence the transaction groups based on the determined operation dependencies; and
replicate the object-based operations in an order determined by said sequencing.

14. The machine-readable media of claim 13, wherein the program code to read object data associated with at least one of the object-based operations includes program code to read namespace object data associated with at least one of the object-based operations, and wherein the program code to determine operation dependencies further comprises program code to:
read data of a first namespace object identified in an object-based operation of a first transaction group;
read data of a second namespace object identified in an object-based operation of a second transaction group;
compare the data of the first namespace object with the data of the second namespace object; and
determine whether an operation dependency exists between the first transaction group and the second transaction group based on said comparing.

15. An apparatus comprising:
a processor; and
a machine-readable medium having program code executable by the processor to cause the apparatus to,
translate each of a plurality of file system commands into a respective transaction group of one or more object-based operations;
assign a same transaction identifier to the object-based operations in each of the transaction groups;
record the transaction groups to an intent log that buffers the transaction groups prior to commitment of the object-based operations to a backend object store; and
commit the object-based operations to the backend object store, wherein the program code to commit includes program code to,
determine for each of the transaction groups, whether the transaction group modifies a file system namespace; and
for each transaction group that is determined to modify the file system namespace, and prior to committing object-based operations of the transaction group,
generate a recovery-begin object that describes the transaction group; and
store the recovery-begin object to the backend object store.

16. The apparatus of claim 15, wherein the program code further comprises program code executable by the processor to cause the apparatus to:
execute each of the object-based operations in the transaction group; and
in response to all of the object-based operations in the transaction group being executed, remove the recovery-begin object from the backend object store.

17. The apparatus of claim 16, wherein the program code further comprises program code executable by the processor to cause the apparatus to:
in response to a system restart event, identify one or more recovery-begin objects within the backend object store; and
for each identified recovery-begin object, execute each of the object-based operations contained in the recovery-begin object.

18. The apparatus of claim 17, wherein the program code further comprises program code executable by the processor to cause the apparatus to assign a specified object name to the recovery-begin object, and wherein the program code to identify one or more recovery-begin objects comprises program code to search an object container using the specified object name as a search key.

19. The apparatus of claim 15, wherein the program code further comprises program code executable by the processor to cause the apparatus to:
read object data associated with at least one of the object-based operations;
determine operation dependencies among the transaction groups based on the object data;
sequence the transaction groups based on the determined operation dependencies; and
replicate the object-based operations in an order determined by said sequencing.

20. The apparatus of claim 19, wherein the program code further comprises program code executable by the processor to cause the apparatus to:
read namespace object data associated with at least one of the object-based operations;
read data of a first namespace object identified in an object-based operation of a first transaction group;
read data of a second namespace object identified in an object-based operation of a second transaction group;
compare the data of the first namespace object with the data of the second namespace object; and
determine whether an operation dependency exists between the first transaction group and the second transaction group based on said comparing.
